(19) United States
(12) Patent Application Publication
(10) Pub. No.: US 2010/0125469 A1
(43) Pub. Date: May 20, 2010

(54) METHODS AND A SYSTEM FOR REMOTELY AUTHORIZING AND MONITORING FINANCIAL TRANSACTIONS

(75) Inventors: Matija Roblek, Ljubljana-Sentvid (SI); Andrej Brilly, Lbujljana (SI); Denis Roblek, Ljubljana (SI)

Correspondence Address: K&L Gates LLP, P.O. Box 1135, CHICAGO, IL, 60690, US

(73) Assignee: DOM KREDIT D.O.O.

(21) Appl. No.: 11/722,684

(22) PCT Filed: Dec. 22, 2004
(86) PCT No.: PCT/EP04/14641

§ 371 Date: Apr. 13, 2009

(51) Int. Cl. G06Q 40/00; G06Q 10/00; G06F 15/16; G06F 3/048

(52) U.S. Cl. 705/7; 705/44; 709/206; 715/780

(57) ABSTRACT

The present invention relates to a method and a system for remotely authorizing and monitoring financial transactions, and for automatically performing executing procedures, if required. In particular, the present invention envisages a computer program product comprising program code means for carrying out the present method, a system for authorizing financial transactions and a computer data signal embodied in a carrier wave and representing a program that instructs a computer to perform the steps of the present method.

The present invention relates to a method and a system for remotely authorizing and monitoring financial transactions, and for automatically performing executing procedures, if required. In particular, the present invention envisages a computer program product comprising program code means for carrying out the present method, a system for authorizing financial transactions and a computer data signal embodied in a carrier wave and representing a program that instructs a computer to perform the steps of the present method.

### STATE OF THE ART

Conventional procedures for resolving credits take much time. In most cases, a number of check-ups are required and there aren't any automatic backup systems which may guarantee the easy and speedy credit approval.

When a customer enters a retail store and desires to purchase a certain item for which he needs a credit, he desires to have this credit approved as soon as possible with no extra delays regarding formalities and no searching for extra documentation. However, with the conservative procedures banks and the like can't perform as would be desirable. Often, the customer has to fill in many paper forms in the retail store, which the bank or creditor require.

In most cases, the customer had to submit these forms first to his employer who gave a signature and a rubber stamp mark, confirming his employment in the respective company. After having been signed, these forms were handed to the bank where the costumer's account is located. When all these matters were finalized, the customer now could return to the store and hand out the forms/papers to the retailer. The retailer then sent all the documentation from the customer to the bank for a counter-check and approval.

Today's procedures of credit approval take about one or more days, which often led to customers changing their minds about the purchase using the credit, and resulting in retailers loosing potential customers.

In order to solve this problem, some banks tried to speed up mail delivery, by which the contracts were transferred from the bank after approval back to the retailer. Yet, this faster delivery added to the costs and did not substantially reduce the entire time period, the customer had to wait for after all.

Additional problems arose because of arrears which are not paid by the debtor which kind of situation similarly holds true for executing procedures, i.e. for debtors not fulfilling the contract by not performing the necessary repayments.

In general, conventional executing procedures suffer from requiring too much time, which is mainly based on the fact that most of the creditors do not have automatic procedures by which they could easily control the entire executing procedure and be involved only in those procedures which are important and which can not be executed without their presence.

The creditor is managing the executing address or document credibility. Based on these documents the creditor has to send a proposition form for execution on which all the data must be filled in which is demanded by the court. In some cases, these proposition forms are filled in incorrect so the court sends it back to the creditor, as he is required to fill it in again.

In case a creditor has a legal interest which means that he manages the executing address by himself he must perform some inquiries at different banks and other institutions which manage the debtor's data all by itself which can take a lot of time, and extra unnecessary expenses are made.

Deadlines in all the legal matters are very specific, that is why the creditor has to have the exact evidence of when some execution resource is ended, when he has to suggest the next execution source, when he has to pay the expenses, when he has to make advanced payment for the executor and so on. Every procedure can take a while because of incomplete documentation delivered or contradictions, of which there are far too many. That is why these kinds of legal procedures may take even 10 years or more. That is why many creditors give up their wish to reclaim the debt or they just hand over his claim to some other law firm, which charges a lot of money.

In today's practice, the creditor has to find an attorney with whom he finds out on which grounds they will reclaim his debt. They prepare the documentation, and creditor or attorney then have to find some extra data about the debtor or his assets. When the data is collected the next step is to find out what the court fee is, which must be paid by the creditor so the reclaiming procedure can be started. All these expenses must be defined in the proposition form for execution. Because there are multiple parameters to be considered it is necessary to look up many charts where the expenses are found.

When the actual asset of the debtor is stated the creditor has to know on which grounds he will reclaim his debt, in other words he has to define by which resource he will reclaim his debt. In the next step the court can prepare the proposition for the execution. When the court issues the closure, the debtor has a right to give an objection. The creditor can then object in an 8-day period on the debtor's objection. All this notifying can take a long time and the objection can be send too late. In practice most of the communication is made by regular mail, which can take a lot of time. If it is known that there has to be a reply on the debtor's objection the creditor has to be very careful not to forget to reply. This could mean a few days of delay or even suspension of the executing procedure. Thus, all the expenses are basically spent useless. In case the debtor's objection is approved the executing procedure is stopped and the lawsuit begins. Of course the exactness can be guaranteed but in today's procedures there have to be a lot of people who are checking all the documentation and are coordinating whole procedures.

Therefore, there is a need for obviating the above problems and to provide means for handling financial transactions and performing the appropriate execution procedures, if necessary.

### SUMMARY OF THE INVENTION

The above problem is solved by providing a method for authorizing financial transactions that comprises the steps of inputting a request for a transaction from a requesting entity; determining if said request can be approved without external check; and if said request can be approved without external check establishing a positive approval decision; if said request can not be approved without external check, sending data indicative of said request to an external checking entity; receiving an approval decision from said external checking entity; in case of a negative approval decision denying approval of said request; and in case of a positive approval decision granting said request.

### THE FIGURES

FIG. 1 schematically shows the registration of a new retailer in the system;

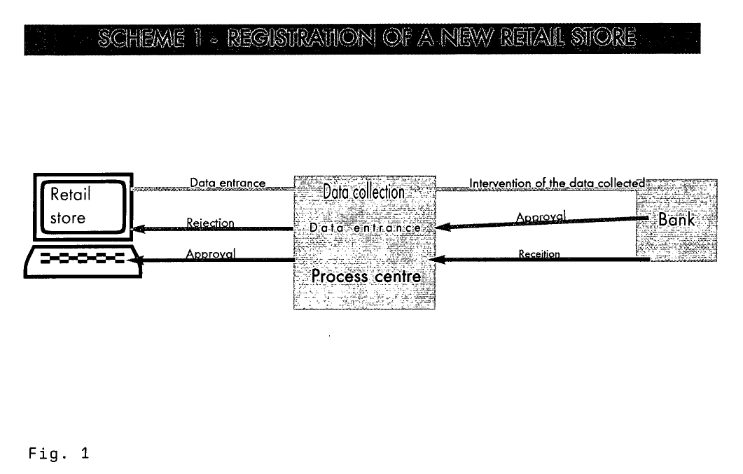

FIG. 2 schematically shows the automatic approval.

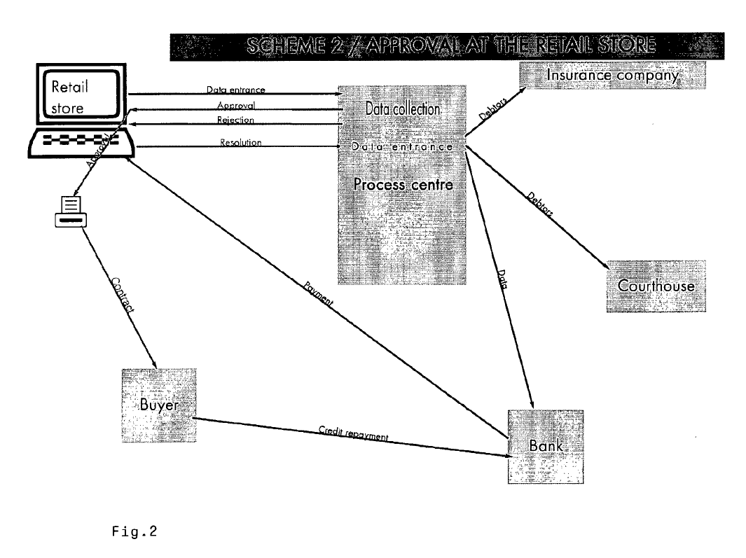

FIG. 3 schematically shows approval with extra bank inquiry.

FIG. 4 schematically shows executing procedure.

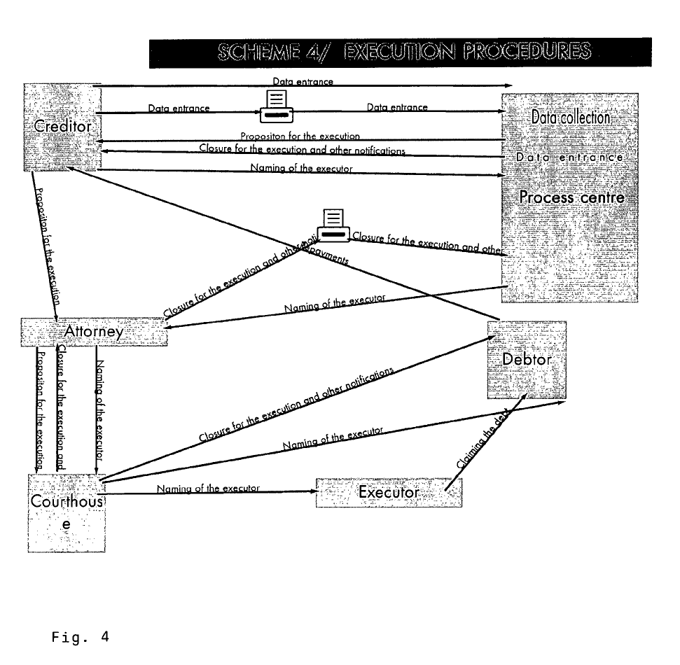

FIG. 5 shows potential combinations.

### DEFINITIONS AND FEATURES OF THE INVENTION

In the present specification the following definitions shall apply.

The term person shall refer to a natural person, i.e. referring to the citizen of a particular country who can be identified with his ID card.

The term manual approval divides the procedure of making a credit on two steps. The first step is filling the application, which is the retailer's job. The second step is checking the application and all the documentation in the bank.

Automatic approval allows an instant approval, if all validations are approved.

Validation procedures are the procedures, which prevent the illegal abuse of the system. If the validation procedure denies the approval the credit cannot be taken.

Credit scoring means that the evaluation of the credit risk is based on the parameters entered, which evaluate the potential debtor, and then based on these parameters it is decided whether further procedures will take place.

Every form of credit can make other multiple options. This means that inside of every form of credit a particular option can be chosen. Like for instance when we are talking about validation procedures, which can be limited on the customers, height of credit, type of employment, etc.

The way of calculating interest is left to the bank and what is set. The bank may choose between any of the different well-known calculations. The calculation may be changed regarding the type of credit.

The process centre can make it possible that on the day of drawing the credit, the intercalary interest can be newly calculated and then be added to the principal.

The servers are physically well protected. The access to the servers is possible only to authorized persons who work in the respective company. The main server system has also got another location.

For Administrative server protection the access to the production can only be possible through the interfaces.

Access through the interfaces is possible with valid certificate, user name and password, which is important for the bank as well as for the retail store.

Resolving credits is fully automatic, so that the accompaniment is also fully automatic. When the credit comes to the present system next steps that take place are drawing of credit, sending payment orders (e.g. 6 different types of payment orders (regular payment order, first admonition, second admonition, third admonition, admonition before resignation, resignation from the contract), the cession procedure for the resigned contracts; handling claims; and any more which are important for controlling a credit.

### DETAILED DESCRIPTION OF THE INVENTION

The present invention resides in the development of a method and a system which enable financial organizations, such as banks, to resolve all types of credits, leasing and other forms of money lending to authorized stores in the quickest and easiest possible way. The present remote authorizing method and system provide a kind of “relocation” of a banks counter directly to the respective store such that the seller becomes the banker for a few minutes. Retail stores or point of sales may register in the present system and input data of a potential debtor. This procedure offers an instant data check, a calculation of credit risk and definition of the credit amount and the consumer risk. If the debtor is a potential risk investment, the data is sent directly to the bank for a supplementary check up.

In case the debtor is risk-free, the credit may instantly be resolved in the retail store. The system prepares a contract which the seller gives to the debtor for signature. The original contract—with all related documents—is sent to the bank or the company's headquarters, which also manage the system. The system checks the original documentation regarding the contract and the funds are then paid to the retailer.

The repayment procedure, which is fully automatic, is now started for the debtor. The system subsequently sends to the debtor his monthly payment bill. If the arrears are not paid, the debtor gets admonitions and other notifications. The system also provides an individual debtor controlling.

If the debtor is behind with his payments for a particular period of time, he is resigned from the contract. The repayment claim can then be sold or carried out by law procedures to its final repayment. In the latter case, the debtor is then handled further by the execution part of the system. That is, the part of the system which automatically carries out the executing procedures via court, and which assists the creditor to reclaim the customers' debt. Both parts of the system may become an independent system or may be integrated in a single system. Also, both of them may be implemented as a web application.

After this action, the procedure of reclaiming the debt is taking place through the law institutions, in which case the law firm, legal executor and other persons having the legal permission of reclaiming the debt are included in the execution part of the system. All the procedures and formal notifications are led by the system automatically. This means that the system is leading the data regarding individual debtors and their annuities or repayment fees. The creditor is constantly reminded and notified about what he must do in an individual case. All the necessary documentation is sent to the creditor automatically, all he must do is hand over the documentation to an attorney, courthouse or the executor, if required. Both described system parts have automatic answering machines for backup, through which all users can ask for the necessary documentation, in case the preferred web application solution is temporarily out of order or inaccessible for some reason.

The present system enables financial organizations, e.g. banks, to offer their loans in the retail stores in a very simple way. The system is reliable, secure and easy.

In order to be performed, the system includes banks' offers for credits and also retailers which are subscribed to the system, with all the data from the customer who wants to take a credit being included as well.

A new bank is signed in such that it its parameters regarding credits are entered into the system. The bank may set the maximum height of credit taken, approval costs, insurance costs, payback period, interest rate, interest on arrears and also the payment conditions and admonition editing.

If a store wants to claim credits via the present system it also has to sign in first. The retailer enters data referring to the name of the company, tax and registration number, the number of an account etc. After that the retailer enters the data about his store. The main data are the name and the address of the store, how much sales per month are expected, the store's size and also the names of all the employees who will be enabled to make credits in the store.

The application is then forwarded by the system to the risk department of the respective bank or creditor. Based on the decision of the risk department, the system prepares the contract for handing out credits and sends it to the retailer, for example by e-mail. The retailer subsequently signs the contract and sends it to the creditor's headquarters. Based on the signed contract the system prepares a number of certificates for handing out credits for the retailer. These certificates are intended for better security of making business and they guarantee a better tracing.

A flowchart for performing the present system is illustrated in the figures/schemes.

First, as it is shown in scheme 1, the seller signs into the system indicating his data about his store and company. After that a bank sends him a cooperation contract, when the retailer sends back the signed contract after this a certificate is given to him.

Then, he enters the credit amount to be taken (cf. scheme 2). The procedure starts when the seller enters the data about the customer/the debtor. As regards the sort of credit and the amount requested, the credit will be approved or the system demands extra documentation. If the amount taken is relatively low, the credit will be approved automatically. The retailer just enters the basic data about the customer in the system. When signing in is completed, the retailer confirms the data entered and then he will check the basic validations. The data are sent to the server on which the present system may be run, where the credit risk may be evaluated by examining all the data. The system performs a control of the name, surname, home address, ID number, tax number and is also inspecting his employment as stated in the contract. Subsequently, a cross examination is carried out during which the system compares whether the name and surname matches the tax number. If all validations are correct and the system does not reject the customer, liquidity is then checked with the help of the POS terminal on which the state of the transaction account is checked. If the account is active and there is enough money in it, the first annuity will be paid. The contract is then made and the credit is approved. Subsequently, the signed contracts are sent to the headquarters of the company running the present system where all the contracts are scanned and the fully automatic system allows that the contracts liquidate on its own.

A liquidated contract then results in a process of sending notifications by which the bank gets the green light for paying the funds to the retailer and also paying the insurance premium to the insurance company. The bank also receives the data referring to the debtor. All these notifications are automatically prepared and send, preferably by e-mail.

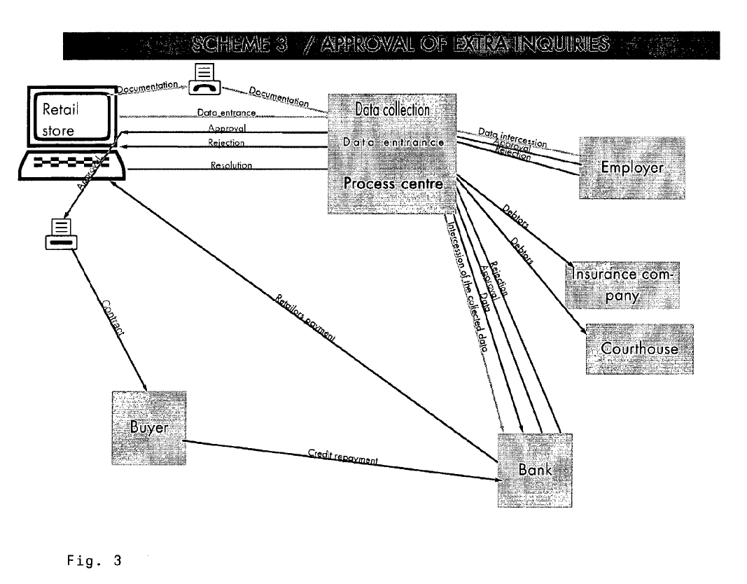

When higher credits are concerned the system is quite similar, and only distinguished in some procedures as is shown in FIG. 3 (Scheme 3). Here, the retailer signs up in the system with his own user name and password. He then enters the credit amount taken. Regarding the amount written in the system the payment conditions and all the documentation are generated, which have to be placed by customer. The data about the customer are then entered in the system and the application is made. When signing in is finalized, the retailer confirms and checks the validation process. The data is sent to the server, on which the present system is run and on which a data check up takes place. The system performs a control of the name, the surname, home address, ID number, tax number and also checks the employment as stated in the contract. A cross examination is then carried out, wherein the system ensures whether the name and surname matches the tax number. All the necessary documentation, which is demanded by the system, is then sent to a fax number. Before the fax message is sent, it is necessary to enter a digit code, which is displayed on the computer screen. That is, how the system places the application together with the proper documentation.

If the bank demands a confirmation form from the employer, an extra e-mail or fax notification is sent to the employer who then sends it back to the fax number, signed and rubber stamp marked. However, before sending the application the digit code must be entered. Based on this digit code the system can match the confirmation form to the proper documentation as regards this customer. Before the merchandise is being taken, the customer has to present the signed and rubber stamp marked confirmation form from the employer.

If the bank demands warrantors when taking a credit, the data regarding the warrantors can be signed in, through the sign-in-application. The data is then sent to the fax number like the already described procedure above.

The system perceives the written applications and based on the sent documentation on the fax number the whole application form is transmitted to the banks where the application form and the entire documentation are examined. If the documentation is appropriate and all the validations are correct the contract is sent to the retailer who then prints out the contract and gives it to the customer for signing. The credit is now approved.

In both cases described above, the signed contracts are sent to the headquarters of the company running the present system where they are scanned and liquidated in a fully automatic manner. In case the contract doesn't provide all the required elements, the contract is sent back to the retailer with an explanation why the contract was rejected. Then he has to fill in the missing elements and send it back again. The liquidated contract then causes the process of sending notifications by which the bank gets the green light for paying the funds to the retailer and also paying the insurance premium to the insurance company. The bank also receives the data referring to the debtor. All these notifications are automatically prepared and sent, preferably by email.

In case of unpaid arrears the debtor is turned over to the insurance company and the system transfers the customer directly to the execution part of the system.

The present system allows handling of all types of credits. For persons, companies, short term, long term credits, mini, mortgage, or leasing for example.

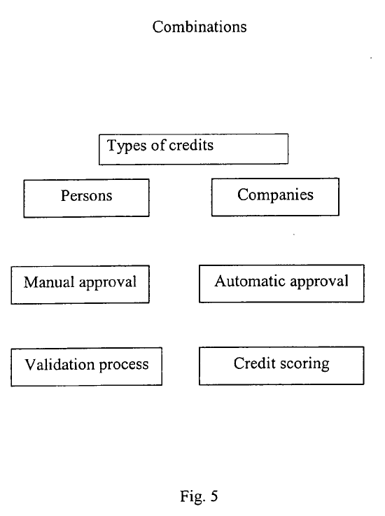

The authorizing part of the system may be combined in 6 forms, which may be derived in more detail from FIG. 5. That is, how the optional form of credit can be made. For instance, a mini credit is a combination of credits for persons, automatic approval and validation procedures.

The first and the second level are excluded. This means that the credit cannot be approved to both a person and the company, i.e. it cannot be approved manually and in the same time automatically. Yet, the credit can go through validation process and risk evaluation.

As may be drawn from the above illustration, one of the basic innovation of the present system resides in automation. The entire controlling of a credit is related to the time factor. This means when the drawing of a credit takes place there is a plan prepared which is the foundation of credit controlling. Next step is every day check up if the conditions are executed. In case the conditions are not executed, for instance a customer is not paying regularly so he gets one type of admonition. All this procedures doesn't need a person to take care of it. The computer manages these assignments all by itself and in the same time checks if he did it correctly.

Apart from the time reduction, another advantage of performing the present method is an extreme reduction of operating expenses, even up to 90%.

The second advantage brought about is an improved handling of claims. The claims come into the bank in written forms, e-mails or through answering machines. All these claims are combined and rearranged to 8 different types of claims (inquiry about the current debt, specified interest on arrears, specified admonitions sent, address modification, repayment period, modification, sending admonition duplicate, approval/rejection of repayment period modification). Each type of claim is solved on its own way. This means if the claim is type 1, the specific procedure takes place where the customer is checked and then he gets his detailed explanation. The essence of this innovation is in handling claims, which is fully automatic, and there actually is no need for anyone who would solve them. In case the system does not know how to solve it then the claim is send to the administrator.

The present system uses a special protocol which otherwise uses the old technology but is quite improved.

The store signs in the application for a credit, which is then sent to the bank. In the same time the retailer gets his 6-digit code. The retailer then sends this application through the fax machine on which he has to enter this digit code. Based on 6-digit code, which was sent with application, the program combines the application with all the documents, which are then sent to the bank for authorization.

The execution part of the system is a computer system (cf. scheme 4), which enables all kinds of creditors, persons and companies to send an executing claim based on the executing address or document credibility. The system manages all the executing procedures through the courthouse in a fully automatic manner. It may be implemented as a web application, which can be part of the authorizing part of the system or may be totally independent.

The creditor signs in the system and begins entering his debtors. The automatic system runs the executing procedure through the courthouse or law institutions. In this procedure the law firms are signed in the system and also the law executors or other authorized persons, which can reclaim the debt, by law.

The system is constantly notifying its users about the procedures for an individual debtor and is reminding at all times what needs to be done for the next step in the procedure. The system is also sending all the documentation on the desired addresses to all users of the system.

In practice, in all the long-term court procedures documents may often be misplaced or even lost, that is why finding new documentation may cause a number of problems. The system is arranged so that the user may always and instantly get this documents and all the information about the debtor, his payments and momentary state of the debtor.

The potential creditor enters his data through the form in the system. The administrator then checks the form sent and if everything is in order, the system prepares the contract, which is then send back to the creditor by e-mail for signing.

When the creditor returns the signed contract, the certificate is automatically sent and also the instructions for use. With this the creditor gets a permission to access the application. A creditor can define user name and password.

The execution part of the system may also include answering machines for back up system by which the messages and all the documentation is received. The system then arranges and uses them in the procedures. These documents are saved on a special server.

The following general example illustrates the invention without limiting it thereto.

### Example of Credit Approval and Managing Execution Procedure

A customer comes into the store where he wants to take a credit for purchasing an item. The retailer, who is activated/included in the present system, may access the web site, on which the system may be run via computer, which is connected to the Internet.

At the web site the retailer enters his user name and password and then confirms the entrance. The data is subsequently transferred to the server where an automatic check of user name and password is in progress. If the data is correct a retailer will be able to begin entering data of a customer. If the data is incorrect, the server will reject the user's request.

The customer gives details about his ID card, account card and also indicates his tax number, which the retailer enters on the application. He may also ask the customer some additional questions, referring to the BASLE II standard, and he also enters data about the customer's employment.

After all the data have been entered, the retailer confirms the entrance. The data is then transferred to the server where they are examined and cross-checked.

If the customer is not rejected, he will be awarded a credit of a given and limited amount.

If the customer desires to obtain a higher credit, the bank will demand more documentation. The beginning of the procedure is the same as above with the proviso of including the additional procedures: In case the customer is not rejected, the server will automatically prepare an employment application and an application for the bank. Employment application and application for the bank are both printed by the retailer in the store. Both applications are associated with a 6-digit code, which is already printed on the application forms. The retailer then transmits the applications through the fax machine to the employer and to the bank.

When the applications are approved by bank and by the employer, they are sent back to the system via the fax machine. Before sending the application, they both enter the 6-digit code. The fax message comes to the server, where it is transformed in a image format which is then—by means of the 6-digit code attached—the application of the customer.

When all the required documentation is collected, the server sends the entire application via e-mail to the bank, where the application is either approved or rejected. If the application is approved, the bank will mark it in the present system and will notify the retailer via an e-mail that the credit is approved. In case the application is rejected, the procedure stops.

If the amount of credit is too high and if a customer needs a warrantor, then the whole procedure detailed above has to be checked for the warrantor as well. As soon as the credit is approved, the data about the customer is entered in the server base.

After the creditor has signed in the system, he enters his user name and password in the system and begins to enter the debtors' data and confirms the entry. The system will check the data and will perform cross-examination of the data. Is any faults are found in the data, the system will notify the creditor.

When the data is entered in the system it is also entered on the server. A server makes a payment order for court costs by which the 6-digit code is added. When the creditor pays his court costs, he has to send a confirmation of the payment through the fax machine on the server. Before sending the confirmation he has to enter his 6-digit code.

The fax message is sent on the server, where it is transformed to the image format, which is then with the help of 6-digit code attached to the application of the proposition for the execution. The creditor then enters 6-digit code and sends a copy of his account book through the fax machine. In his account book there is information about the customers' debt.

When the entire documentation is considered to be ready, there is made a proposition for the execution, which is sent to the creditors' e-mail.

The creditor prints the proposition for the execution, marks it with his signature and rubber stamp and transmits it to an attorney, which also signs it and marks it with his rubber stamp and sends the proposition to the courthouse.

The courthouse makes the closure, which is sent back to an attorney. An attorney enters the debtors court number which is then saved on the server. The server gives the debtor his 6-digit code and a copy of the closure is sent to the creditors e-mail.

A server attaches all the documentation, which has this particular 6-digit code together, which is then saved in one place. The procedure is the same for all the rest of the documentation, which is send by the courthouse. The procedure takes as long as all the debt is paid off or as long as the claim does not become superannuated.

1. A method for authorizing financial transactions, comprising the steps of:
inputting a request for a transaction from a requesting entity;
determining if said request can be approved without external check; and
if said request can be approved without external check establishing a positive approval decision;
if said request can not be approved without external check, sending data indicative of said request to an external checking entity;
receiving an approval decision from said external checking entity;
in case of a negative approval decision denying approval of said request; and
in case of a positive approval decision granting said request.

2. Method according to claim 1, wherein granting said request involves preparing and outputting a contract related to said request, for signing by said requesting entity.

3. Method according to claim 1 or 2, wherein said data indicative of said request comprise at least one information of the group consisting of:
name of requesting person;
address of requesting person;
age of requesting person;
tax number of requesting person;
social insurance number of requesting person;
monetary amount of requested transaction;
payment details for said requested transaction; and
a unique ID of the requesting person.

4. Method according to claims 1-3, further comprising sending the signed contract to said checking entity.

5. Method for authorizing financial transactions, comprising:
receiving data indicative of a requested transaction from a requesting entity;
determining if said request may be approved by using a set of pre-defined rules to check said data; and
establishing a negative approval decision, if a pre-defined threshold number of rules are not fulfilled by said data; or
establishing a positive approval decision, if a number of rules less than said pre-defined threshold number are fulfilled; and
sending an approval decision based on said determining outcome.

6. Method according to claim 5, further comprising
sending data indicative details of a contract related to said request.

7. Method according to claim 5 or 6, further comprising
receiving the signed contract.

8. Method according to claim 8, further comprising:
checking if said contract is fulfilled; and if it is not fulfilled
sending a notification thereof to the contractor.

9. Method according to claim 8, further comprising
sending data indicative of said non-fulfilled contract and of said entity not fulfilling said contract to an execution entity.

10. Method for performing execution procedures related to a non-fulfilling of a financial transactions contract, comprising:
receiving data indicative of said non-fulfilled contract and of the entity not fulfilling said contract;
preparing required forms related to said execution procedures by inputting data concerning the not fulfilled contract and the entity not fulfilling said contract; and
outputting said filled in forms.

11. Computer program product comprising program code means for carrying out the method of anyone of claims 1 to 10 when said program product is run on a computer or network device.

12. Computer program product comprising program code means stored on a computer readable medium for carrying out the method of anyone of claims 1 to 10 when said program product is run on a computer or network device.

13. Computer program product comprising program code, downloadable from a server for carrying out the method of anyone of claims 1 to 10 when said program product is run on a computer or network device.

14. Computer data signal embodied in a carrier wave and representing a program that instructs a computer to perform the steps of the method of anyone of claims 1 to 10.

15. System for authorizing financial transactions, comprising:
at least an input terminal comprising means for inputting a transaction request and for sending data indicative of said request, and for receiving approval decisions related to said request;
a main server being connected to said at least an input terminal, said server storing a list of pre-defined rules for checking a financial transaction request,
said server comprising:
means for receiving data indicative of a transaction request,
means for utilizing said list of rules to determine if a financial transaction can be approved, and
means for sending an approval decision to said input terminal.

16. System according to claim 15, further comprising
means for preparing and outputting a contract related to said transaction request.

17. System according to claim 15 or 16, further comprising
means for receiving the contract after it has been signed.

18. System according to claims 15-17, further comprising
means for periodically checking if the details of said contract are fulfilled; and
means for preparing and sending a notification, if said contract details are not fulfilled.

19. System according to claims 15-18, further comprising
means for preparing, filling out forms required for performing execution procedures related to a non-fulfilling of said contract details, and for sending said filled out forms to an appropriate legal authority.
